(19) United States
(12) Patent Application Publication
(10) Pub. No.: US 2025/0045741 A1
(43) Pub. Date: Feb. 6, 2025

(54) INTEGRATED SELF-CUSTODY CRYPTOGRAPHIC TRANSACTIONS

(71) Applicant: SAP SE, Walldorf (DE)

(72) Inventors: Stefan Arnold, Leimen (DE); Brit Panzer, Mannheim (DE); Stefan Schmid, Rauenberg (DE); Raffael Lutz, Bad Schönborn (DE); Bernhard Schweizer, Nussloch (DE); Alessandro Gasch, Berlin (DE)

(21) Appl. No.: 18/925,424

(22) Filed: Oct. 24, 2024

Related U.S. Application Data
(62) Division of application No. 18/300,447, filed on Apr. 14, 2023.

(51) Int. Cl. G06Q 20/38; G06Q 20/36

(52) U.S. Cl. CPC G06Q 20/3825; G06Q 20/36; G06Q 20/389

(57) ABSTRACT

This disclosure describes systems, software, and computer implemented methods including receiving a request from a second entity to transfer a digital asset to a first entity. Receiving a request for an address and public key is sent to an asset custody application executing on a device that is managed by the first entity. Receiving, a public key and a wallet address and sends the wallet address to the second entity. Further this disclosure describes receiving a request to transfer a digital asset from a first entity to a second entity. Generating a transaction package pursuant to the one or more parameters, the transaction package including a transaction and a public key of a digital wallet associated with the first entity. Executing the transaction and sending the signed transaction package to a distributed ledger.

### CLAIM OF PRIORITY

This application is a divisional of, and claims priority to U.S. patent application Ser. No. 18/300,447, filed Apr. 14, 2024, titled “INTEGRATED SELF-CUSTODY CRYPTOGRAPHIC TRANSACTIONS” (Attorney Docket No. 22135-1712001/220722US01), the contents of which are incorporated herein by reference in their entirety.

### BACKGROUND

Blockchain or distributed ledger technology has enabled complex transactions occurring in multi-party environments. Usually transaction approval requires a digital signature generated using a private key of a private/public key pair and asymmetric encryption. Custody of the private key has significant security and legal implications, as the entity having access to the private key can initiate, or complete transactions.

### SUMMARY

The present disclosure involves systems, software, and computer implemented methods for receiving a transfer of a digital asset. This can include receiving a request from a second entity to transfer a digital asset to a first entity. The request can be received at an asset management application executing as a cloud service and managed by a provider. A request for an address and public key is sent to an asset custody application executing on a device that is managed by the first entity. The asset management application receives, from the asset custody application, a public key and a wallet address and sends the wallet address to the second entity.

Implementations can optionally include one or more of the following features.

In some instances, the asset custody application maintains a private key associated with the wallet address on the device controlled by the first entity.

In some instances, the wallet address is used by a second entity to transfer a digital asset from the second entity to the first entity. In some instances a distributed ledger is monitored to confirm a transaction of the digital asset into a wallet associated with the wallet address has occurred.

In some instances, the provider is different from the first entity.

In some instances, the request to transfer the digital asset to the first entity includes a digital asset type and identifies a distributed ledger on which a transaction transferring the digital asset to the first entity is to occur.

The present disclosure further involves systems, software, and computer implemented methods for providing a transfer of a digital asset. This can include receiving a request to transfer a digital asset from a first entity to a second entity at an asset management application executing as a cloud service managed by a provider, the request including one or more parameters. The asset management application can generate a transaction package pursuant to the one or more parameters, the transaction package including a transaction and a public key of a digital wallet associated with the first entity. When the asset management application receives an approval, it can execute the transaction by sending the transaction package to an asset custody application executing on and managed by a device controlled by the first entity, using a first communications channel, receiving from the asset custody application, via a second communication channel different from the first communication channel, a signed transaction package including a signed transaction, and a signature generated using a private key of the digital wallet, validating the signed transaction package, and sending the signed transaction package to a distributed ledger.

In some instances, sending the signed transaction package to the distributed ledger includes broadcasting the signed transaction to one or more nodes operating an Ethereum blockchain. In some instances the signed transaction is sent to Bitcoin or Ethereum (EVM) compatible Blockchain Nodes, among other cryptographic blockchains nodes.

In some instances, the asset management application monitors the distributed ledger and identifies that the signed transaction has been committed to a block of the distributed ledger.

In some instances the one or more parameters include a transaction amount, transaction type, and a type of digital asset to be transferred.

In some instances the second communication channel is a secure hypertext transfer protocol (HTTPS) channel hosted by the asset management application.

In some instances sending the transaction package to the asset custody application includes sending an authorization token that has been generated by an access service using a X.509 certificate.

In some instances the asset custody application provides authorization to the asset management application using the access service prior to the access service sending the transaction package to the asset custody application.

The details of these and other aspects and embodiments of the present disclosure are set forth in the accompanying drawings and the description below. Other features, objects, and advantages of the disclosure will be apparent from the description, drawings, and claims.

### DESCRIPTION OF DRAWINGS

Some example embodiments of the present disclosure are illustrated by way of example and not limitation in the figures of the accompanying drawings, in which like reference numbers indicate similar elements.

FIG. 1 is a schematic diagram of a system for integrated self-custody cryptographic transactions.

FIG. 2 is a swim lane diagram illustrating an example process for enabling inbound cryptographic transactions.

FIG. 3 is a block diagram illustrating an example process for enabling inbound cryptographic transactions.

FIG. 4 is a swim lane diagram illustrating an example process for enabling outbound cryptographic transactions.

FIGS. 5A and 5B are a block diagram illustrating an example process for enabling outbound cryptographic transactions.

FIG. 6 is a flowchart of an example process 600 for receiving an inbound digital asset transaction by a self-custody management system.

FIG. 7 is a flowchart of an example process 700 for sending an outbound digital asset transaction to a distributed ledger by a self-custody management system.

### DETAILED DESCRIPTION

This disclosure describes methods, software, and systems for providing advanced integration of cryptographic transactions in a distributed ledger environment with a software-as-a-service (SaaS) platform, while maintaining digital wallets under self-custody.

In general, when performing distributed ledger transactions, asymmetric encryption is used to ensure security. A public/private key pair is generated, with the public key being used to authenticate a signature made using the private key in order to confirm that the private key holder has approved a particular transaction. Many blockchains or distributed ledgers require a transaction to include a sender's address, receiver's address, a value, and one or more signatures of the sender which can be used to verify the sender is authentic. In enterprise computing systems or systems that are offered as software-as-a-service (SaaS), most data and computation occurs on a machine that is not owned or managed by the user (e.g., customer). However it is more secure, and in some instances required by regulation, to allow the user to maintain their private keys on hardware they manage or own, or using a neutral, third party contractor. This disclosure describes a solution for enabling a SaaS platform to manage distributed ledger transactions while allowing the user to maintain self-custody of the private keys necessary for the transactions.

The described solution is advantageous in that it enables seamless integration of digital assets such as cryptocurrencies and other distributed ledger based technologies in the SaaS format. This allows users to utilize this technology without concern for the intricacies of directly interacting with distributed ledger nodes. Further, by distributing the private keys to local or self custody, there is no concentration of private keys and as such, less risk of a large-scale digital theft that could result in numerous compromised accounts. By providing complete end-to-end integration for cryptographic digital transactions, the described solution can be readily automated without intermediaries or concerns of legal regulation of certain regions or jurisdictions. This automation can result in faster transaction completion time, improved cost efficiency, reduced security risk to third parties, an increased visibility or transparency between wallet holders and the SaasS platform, and increased user control of the transaction process.

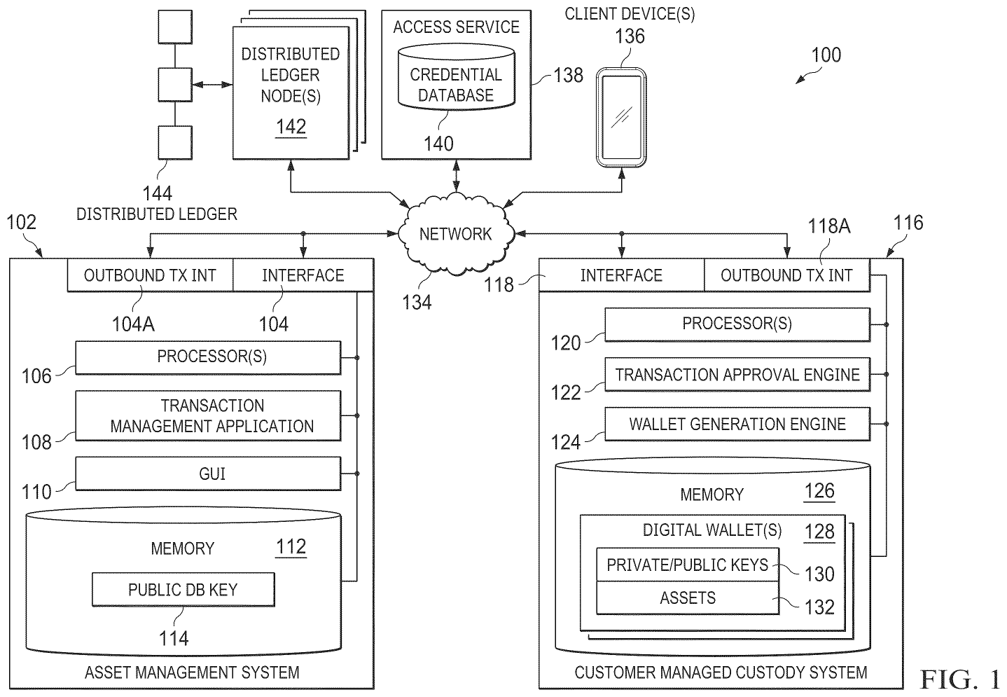

Turning to the illustrated example implementations, FIG. 1 is a schematic diagram of a system 100 for integrated self-custody cryptographic transactions. System 100 includes an asset management system 102 which can be provided as a SaaS application or cloud based enterprise software application. A customer managed custody system 116 is included in system 100 and can be owned, managed, or operated by a client or user, a third party on behalf of a client or customer, or a customer of the enterprise software application. The asset management system 102 and the customer managed custody system 116 operate together to enable secure transactions to and from entities via one or more distributed ledger nodes 142 which maintain a distributed ledger 144. In some implementations, an access service 138 provides credentials and authentication of users, and communications between various components both internal to, and external to system 100.

Asset management system 102 is a system for initiating and executing cryptographic transactions by a user or customer. In some implementations, the user or customer interacts with asset management system 102 via client device(s) 136. Client device(s) 136 can be mobile computing devices such as smartphones, laptops, tablets, or other devices, or fixed computing devices such as a desktop computer, kiosk, or other suitable device.

Asset management system 102 can include one or more processors 106. Although illustrated as a single processor 106 in FIG. 1, multiple processors can be used according to particular needs, desires, or particular implementations of the system 100. Each processor 106 can be a central processing unit (CPU), an application specific integrated circuit (ASIC), a field-programmable gate array (FPGA), or another suitable component. Generally, the processor 106 executes instructions and manipulates data to perform the operations of the asset management system 102. Specifically, the processor 106 executes the algorithms and operations described in the illustrated figures, as well as the various software modules and functionality, including the functionality for sending communications to and receiving transmissions from client devices 136, customer managed custody system 116, as well as to other devices and systems. Each processor 106 can have a single or multiple core, with each core available to host and execute an individual processing thread. Further, the number of, types of, and particular processors 106 used to execute the operations described herein can be dynamically determined based on a number of requests, interactions, and operations associated with the asset management system 102.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including C, C++, JavaScript, Java™, Visual Basic, assembler, Perl®, any suitable version of 4GL, as well as others.

The asset management system 102 can include, among other components, several applications, entities, programs, agents, or other software or similar components capable of performing the operations described herein. As illustrated, the asset management system 102 includes or is associated with the transaction management application 108 and the GUI 110.

GUI 110 interfaces with at least a portion of the system 100 for any suitable purpose, including generating a visual representation of the transaction management application 108 and/or the content associated with any components of the asset management system 102. In particular, the GUI 110 can be used to present results of a transaction or transaction request, or information associated with a digital wallet (e.g., address, balance, public key, etc.), as well as to otherwise interact and present information associated with one or more applications. GUI 110 can also be used to view and interact with various web pages, applications, and web services located local or external to the asset management system 102. Generally, the GUI 110 provides the user with an efficient and user-friendly presentation of data provided by or communicated within the system 100. The GUI 110 can comprise a plurality of customizable frames or views having interactive fields, pull-down lists, and buttons operated by the user. In general, the GUI 110 is often configurable, supports a combination of tables and graphs (bar, line, pie, status dials, etc.), and is able to build real-time portals, application windows, and presentations. Therefore, the GUI 110 contemplates any suitable graphical user interface, such as a combination of a generic web browser, a web-enable application, intelligent engine, and command line interface (CLI) that processes information in the platform and efficiently presents the results to the user visually.

Asset management system 102 includes an interface 104 and an outbound transaction interface 104A. Interface 104 is used by the asset management system 102 for communicating with other systems in a distributed environment—including within the system 100—connected to the network 134, e.g., client 136, and other systems communicably coupled to the illustrated asset management system 102 and/or network 134. Generally, the interface 104 comprises logic encoded in software and/or hardware in a suitable combination and operable to communicate with the network 134 and other components. More specifically, the interface 104 can comprise software supporting one or more communication protocols associated with communications such that the network 134 and/or interface's 104 hardware is operable to communicate physical signals within and outside of the illustrated system 100. Still further, the interface 104 can allow the asset management system 102 to communicate with the client 136, and customer managed custody system 116, and/or other portions illustrated within the system 100 to perform the operations described herein.

Outbound transaction interface 104A can be a dedicated interface, configured to receive particular communications from one or more specific entities such as the customer managed custody system 116. In some implementations, outbound transaction interface 104A utilizes the same physical hardware as interface 104, but is isolated using software. In some implementations, outbound transaction interface 104A represents an API hosted by asset management system 102 and configured to receive signed transactions from one or more customer managed custody systems 116. In some implementations, outbound transaction interface 104A uses a secure hypertext transfer protocol (HTTPS). In some implementations, outbound transaction interface 104A uses other communications protocols, such as serial, TCP/IP, UDP/IP, HTML, or FTP. By maintaining a separate communication channel, security is enhanced. For example, if a malicious third party (and not the asset management system 102) requests a signed transaction from the customer managed custody system 116, it may sign a transaction, but it will transmit it to the outbound transaction interface 104A, and not back to the malicious third party, thereby preventing the malicious third party from acquiring a signed transaction payload.

Network 134 facilitates wireless or wireline communications between the components of the system 100 (e.g., between the asset management system 102, the client(s) 136, the distributed ledger nodes 142, and the customer managed custody system 116 etc.), as well as with any other local or remote computers, such as additional mobile devices, clients, servers, or other devices communicably coupled to network 134, including those not illustrated in FIG. 1. In the illustrated environment, the network 134 is depicted as a single network, but can comprise more than one network without departing from the scope of this disclosure, so long as at least a portion of the network 134 can facilitate communications between senders and recipients. In some instances, one or more of the illustrated components (e.g., transaction management application 108, the access service 138, etc.) can be included within or deployed to network 134 or a portion thereof as one or more cloud-based services or operations. The network 134 can be all or a portion of an enterprise or secured network, while in another instance, at least a portion of the network 134 can represent a connection to the Internet. In some instances, a portion of the network 134 can be a virtual private network (VPN). Further, all or a portion of the network 134 can comprise either a wireline or wireless link. Example wireless links can include 802.11a/b/g/n/ac, 802.20, WiMax, LTE, and/or any other appropriate wireless link. In other words, the network 134 encompasses any internal or external network, networks, sub-network, or combination thereof operable to facilitate communications between various computing components inside and outside the illustrated system 100. The network 134 can communicate, for example, Internet Protocol (IP) packets, Frame Relay frames, Asynchronous Transfer Mode (ATM) cells, voice, video, data, and other suitable information between network addresses. The network 134 can also include one or more local area networks (LANs), radio access networks (RANs), metropolitan area networks (MANs), wide area networks (WANs), all or a portion of the Internet, and/or any other communication system or systems at one or more locations.

Transaction management application 108 can be a cloud or enterprise application that manages the client's digital assets. Transaction management application 108 can initiate creation of digital wallets, and transactions between those wallets and external entities. In some implementations transaction management application 108 maintains and uses a public key database 114 stored in memory 112. The public key database 114 can include a number of public keys, and addresses associated with digital wallets stored within the customer managed custody system 116. In addition to public keys and addresses, the public key database 114 can store other information, such as owner, assets stored, asset balances, identification information, or metadata. The transaction management application 108 can generate invoices to be transmitted to external entities, and requests wallet generation and signatures as necessary from the customer managed custody system 116. In some implementations, the transaction management application 108 monitors inbound traffic at the outbound transaction interface 104A. For example, if an unexpected signed transaction is received at the outbound transaction interface 104A, the transaction management application 108 can send an alert to one or more client devices 136 associated with the wallet owner of the signed transaction indicating that a possible security breach has occurred. In some implementations, the client device 136 interacts exclusively with the transaction management application 108 in order to send or receive digital assets, and the transaction management application 108 handles any additional necessary interaction with the customer managed custody system 116.

Memory 112 of the asset management system 102 can represent a single memory or multiple memories. The memory 112 can include any memory or database module and can take the form of volatile or non-volatile memory including, without limitation, magnetic media, optical media, random access memory (RAM), read-only memory (ROM), removable media, or any other suitable local or remote memory component. The memory 112 can store various objects or data, including digital asset data, public keys, user and/or account information, administrative settings, password information, caches, applications, backup data, repositories storing business and/or dynamic information, and any other appropriate information associated with the asset management system 102, including any parameters, variables, algorithms, instructions, rules, constraints, or references thereto. Additionally, the memory 112 can store any other appropriate data, such as VPN applications, firmware logs and policies, firewall policies, a security or access log, print or other reporting files, as well as others. While illustrated within the asset management system 102, memory 112 or any portion thereof, including some or all of the particular illustrated components, can be located remote from the asset management system 102 in some instances, including as a cloud application or repository or as a separate cloud application or repository when the asset management system 102 itself is a cloud-based system. In some instances, some or all of memory 112 can be located in, associated with, or available through one or more other systems of the associated enterprise software platform. In those examples, the data stored in memory 112 can be accessible, for example, via one of the described applications or systems. As illustrated and previously described, memory 112 includes the public key database 114.

The customer managed custody system 116 is separate from the asset management system 102 and managed or owned by the user (e.g., the customer or a third party). In some implementations, the customer managed custody system 116 is hosted by a third party (e.g., amazon web services) and operated by the customer. It includes one or more processors 120, which can be similar to processor 106 as described above. It also includes an interface 118 and an outbound transaction interface 118A which is uniquely configured to transmit signed transactions directly to outbound transaction interface 104A.

In some implementations, the customer managed custody system 116 receives requests from the asset management system 102 and performs operations according to those requests for completing cryptographic transactions. Specifically, the customer managed custody system 116 performs operations that involve private keys (storage and usage) for the cryptographic transactions. As such, the customer or user maintains custody of their private keys, and the asset management system 102 does not have direct access.

If a request to receive an inbound digital asset is received, the asset management system 102 can request that customer managed custody system 116 generate a new wallet, or otherwise prepare a digital wallet to receive the digital asset. A wallet generation engine 124 can generate a new digital wallet having a unique address, and a private/public key pair. The wallet generation engine can store the newly generated digital wallet as a digital wallet 128 in memory 126. Memory 126 can be the same as, or different from memory 112 as described above, except that it is in the custody of the customer (instead of, for example, an enterprise software provider). In some implementations, each time a new inbound transaction is requested, a new digital wallet 128 is generated. In some implementations, the wallet generation engine 124 further can consolidate, combine, or transfer digital assets 132 between digital wallets 128 in memory 126.

If a request to send an outbound digital asset is received, the asset management system 102 can generate a transaction payload message that includes an unsigned transaction, address or wallet to withdraw from, and an amount to withdraw. In some implementations the transaction payload request includes additional material such as a particular digital asset or asset type, desired transaction time, alternative wallets, metadata, or other information. The unsigned transaction payload can be transmitted via the regular interface (e.g., interface 104 to interface 118 via network 134). A transaction approval engine 122 can verify the transaction, for example, confirming credentials of the asset management system 102, and the balance off the digital asset before signing the transaction using the private key stored in a private/public key database 130 associated with each particular digital wallet 128. Once the transaction is signed, the transaction approval engine 122 can transmit the signed transaction back to the asset management system 102 via the outbound transaction interfaces 118A and 104A. By sending the signed transaction back on a pre-established dedicated channel that is different from the received request, security is enhanced. It is assured that the signed transaction arrives at the asset management system 102, which can halt the transaction if it was not expecting to receive a signed transaction.

In some implementations, an access service 138 is provided, which assures authorization for communications between the asset management system 102 and the customer managed custody system 116. In some implementations, the access service 138 and/or the asset management system 102 utilizes a VPN tunnel or dial-in communications with customer managed custody system 116 in order to enhance security. In some implementations, the access service 138 is provided by an enterprise software provider, and includes a credentials database 140. The customer can register their customer managed custody system 116 with the access service 138, which can manage or control authorized entities (such as asset management system 102) that are permitted to interact with the customer managed custody system 116. For example, the customer managed custody system 116 can require an access token before it accepts any communications with an outside entity. The access service 138 can create and manage access tokens based on the customer managed custody system 116 having registered. Prior to sending a request to the customer managed custody system 116, the asset management system 102 can request and receive an access token from the access service 138, which the customer managed custody system 116 can use to verify that asset management system 102 is an authorized entity.

Once a transaction is signed, or a wallet is generated, the associated wallet address, or signed transaction can be sent to one or more distributed ledger nodes 142 in order for the transaction to be incorporated into the distributed ledger 144. The distributed ledger or blockchain 144 can be maintained and operated by distributed ledger nodes 142. In some implementations the distributed ledger 144 is a public blockchain. In some implementations the distributed ledger 144 is a private blockchain, or a consortium blockchain. The distributed ledger nodes 142 operate together to maintain a distributed ledger 144 that records transactions of digital assets between digital wallets. distributed ledger 144 can be, for example, a Bitcoin blockchain, or an Ethereum blockchain, among other cryptographic blockchains.

After a transaction has been sent or received, the asset management system 102 using, for example, the transaction management application 108, can monitor the distributed ledger 144 for the transaction's incorporation. In some implementations, this requires the transaction to be proposed by one or more distributed ledger nodes 142, then after some consensus mechanism, a new block to be added to the distributed ledger that includes the transaction.

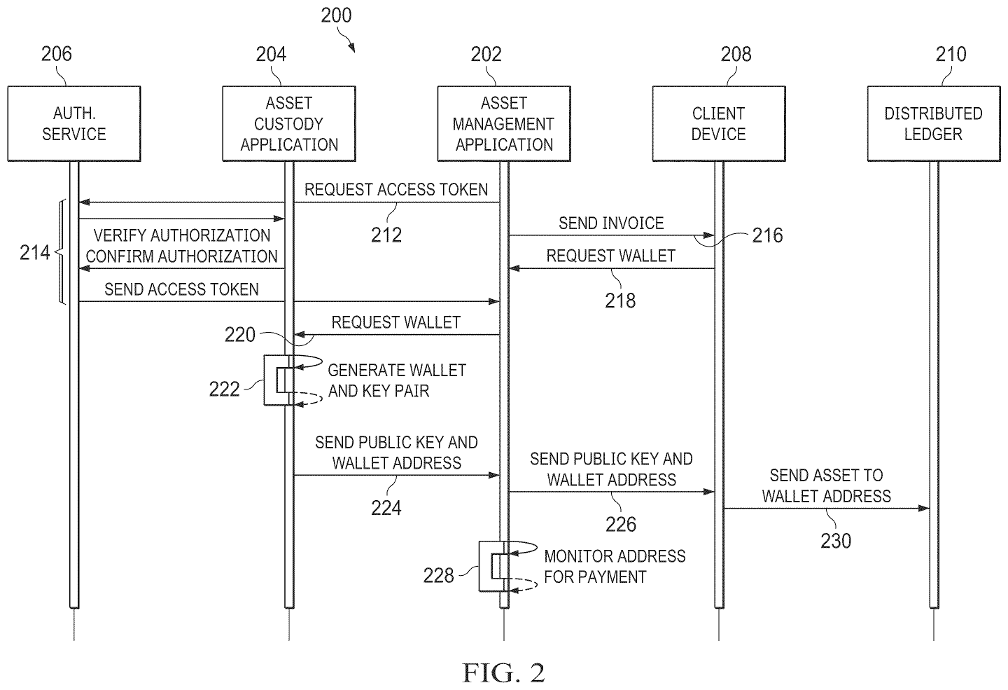

FIG. 2 is a swim lane diagram illustrating an example process 200 for enabling inbound cryptographic transactions. Initially, the asset management application 202 (which can be, for example, asset management application 102 of FIG. 1) can request an access token (212) from an authentication service 206, in order to interact with an asset custody application 204 (which can be, for example, the customer managed custody management system 116 of FIG. 1). The authentication service 206 can confirm with the asset custody application 204 that the asset management application 202 is an authorized entity, and then can generate and sent an access token to the asset management application 202 (214). In some implementations, the authorization service 206 utilizes an open authorization (OAUTH) protocol, or other digital security protocols. For example, the authorization service 406 can use X.509 certificates or other means for providing secure authorization and communication between the asset management application 202 and the asset custody application 204.

In the meantime, the asset management application 202 can send an invoice, or other request for payment or transfer of a digital asset that the client device 208 is to make to the asset management application 202 (216). The client device 208 can request a wallet (218) or a wallet address to which the digital asset is to be sent. In some implementations, the client device 208 requests a wallet (218) if the invoice, or other request for payment or transfer of a digital asset does not already contain such a wallet or wallet address. The asset management application 202 can then request the asset custody application 204 provide a wallet for the client device 208 to send the digital asset to (220). The wallet request from the asset management application 202 to the asset custody application 204 can include the access token provided by the authentication service 206. It should be noted that, in some implementations client device 208 can be a separate asset management application associated with the client, provided at a separate SaaS platform. Client device 208 can be a personal device such as a mobile computer, phone, or other device associated with a customer.

The asset custody application 204 can generate a digital wallet and private/public key pair associated with the wallet (222). In some implementations, the asset custody application 204 generates a new wallet for each inbound transaction. In some implementations, the created digital wallet is a multi-signature wallet, requiring one or more signatures generated by the asset custody application 204, and one or more additional signatures to be provided by offline hardware devices (e.g., “cold storage wallets”). This can enable enhanced security, where the user can maintain a separate hardware device for signing transaction packages in addition to the asset custody application 204. In some implementations, a previously existing wallet is assigned to the transaction, or otherwise made ready to receive the digital asset. For example, where the digital wallet contains multiple different digital assets, a new line item, or index can be created for a new digital asset to be deposited into the digital wallet. Once a wallet is generated (or selected) it's associated public key and wallet address can be send to the asset management application 202 (224). The asset management application 202 then sends the public key and wallet address to the client device 208 (226) in order to enable the client device 208 to transfer a digital asset to the wallet. The client device 208 then can transfer the digital asset to the associated wallet by incorporating the transaction in a distributed ledger 210 (230). In some implementations, incorporation in a distributed ledger requires the transaction to be proposed by one or more distributed ledger nodes, then after a consensus mechanism, a new block to be added to the distributed ledger 210 (230) that includes the transaction. The asset management application 202 can monitor distributed ledger 210 for the expected transaction at the wallet address (228).

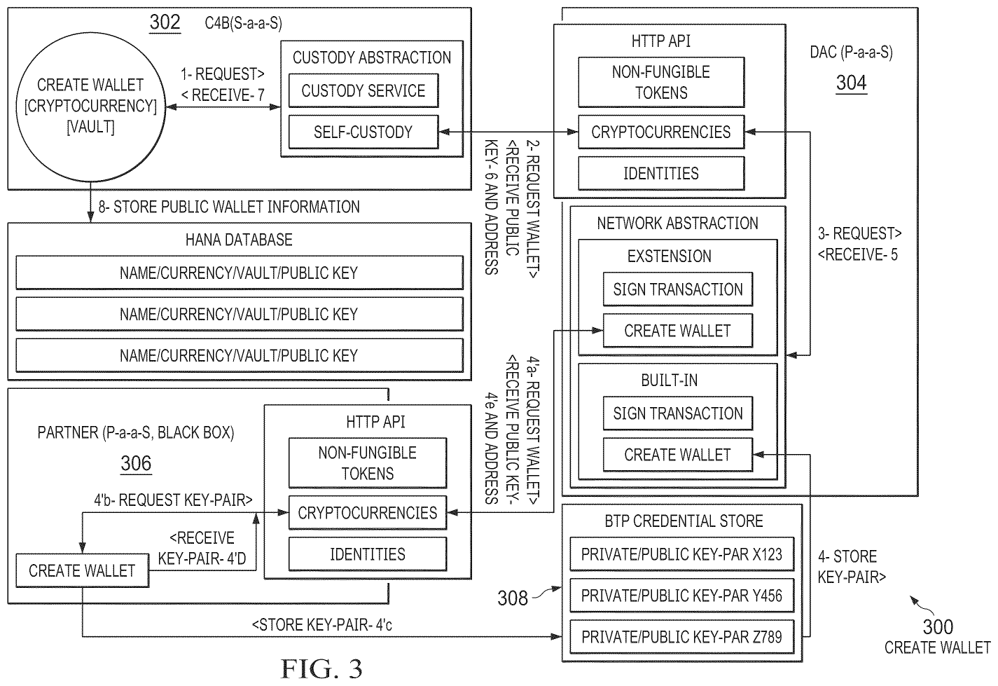

FIG. 3 is a block diagram illustrating an example process 300 for enabling inbound cryptographic transactions. The cryptocurrency for business (C4B) system 302 sends a request to receive a digital through a custody abstraction module, which requests the wallet from a digital asset custody system (DAC) 304. This request can be via a dedicated HTTP/HTTPS API. The requested digital asset can be, but is not limited to, non-fungible tokens (NFTs), cryptocurrencies, digital identities, or other transactable assets. The DAC 304 can then generate or select a wallet, either internally via the “built-in” path, or externally using a partner system 306. Either technique results in a digital wallet generated in a credential store 308, which can then be communicated back to the C4B system 302 and otherwise made available for external entities to deposit digital assets into.

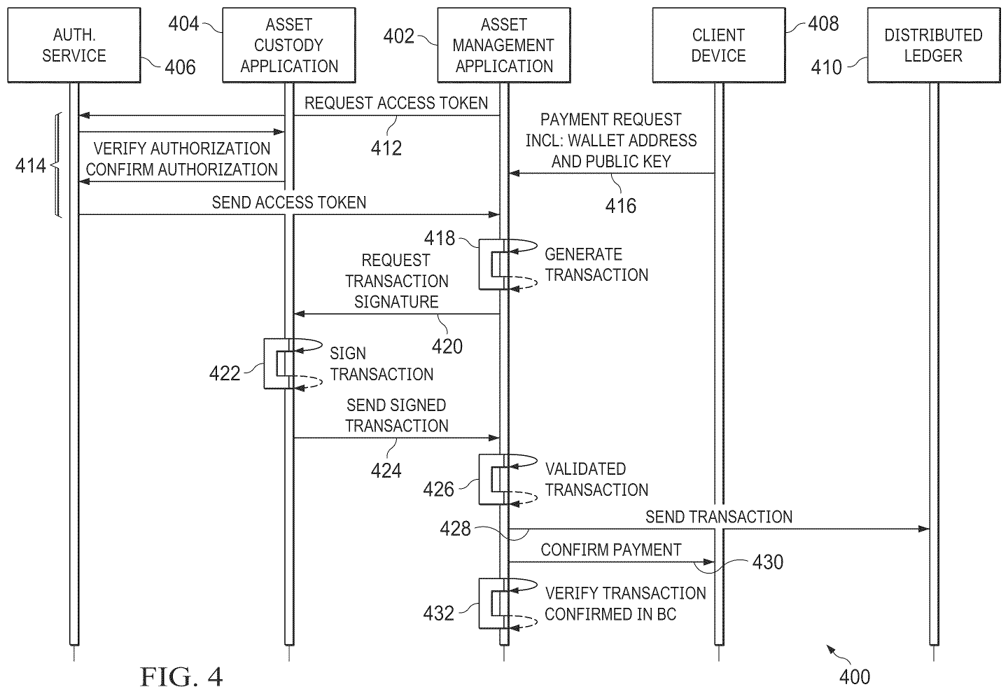

FIG. 4 is a swim lane diagram illustrating an example process 400 for enabling outbound cryptographic transactions. Initially, the asset management application 402 (which can be, for example, asset management application 102 of FIG. 1) can request an access token (412) from an authentication service 406, in order to interact with an asset custody application 404 (which can be, for example, the customer managed custody management system 116 of FIG. 1). The authentication service 406 can confirm with the asset custody application 404 that the asset management application 402 is an authorized entity, and then can generate and sent an access token to the asset management application 402 (414). In some implementations, the authorization service 406 utilizes and open authorization (OAUTH) protocol, or other digital security protocols. For example, the authorization service 406 can use X.509 certificates or other means for providing secure authorization and communication between the asset management application 402 and the asset custody application 404.

In the meantime, a client device 408 associated with a user who is to receive a digital asset from the asset management application 402, can send a payment request, or invoice to the asset management application 402 (416). The payment request can include a public key and a wallet address of the wallet to which the digital asset is to be transferred. The assets management application 402 can generate a transaction that includes all the necessary elements to transfer the digital asset from a wallet associated with the asset custody application 404 to the wallet in the initial request (418). In some implementations, generating the transaction includes requesting permission for the transaction from one or more owners associated with the wallet from which the transaction will occur. The generated transaction is sent with a request for signature to the asset custody application 404.

The asset custody application 404 can then sign the transaction (422) using the private key associated with the providing wallet. That private key is stored exclusively at the asset custody application 404, which is privately owned or managed, and not accessible to the asset management application 402. Once the private key has been used to sign the transaction, the asset custody application 404 can send the signed transaction back to the asset management application 402 (424). In implementations where the wallet from which the transaction will occur is a multi-signature wallet, the asset custody application 404 can provide one or more required signatures, and additional signatures can be provided from an offline wallet (e.g., cold storage wallet, not shown). For example, the asset custody application 404 can provide the first signature, and then send a notification or request to a user to apply a second signature from the offline wallet. In some implementations, the asset custody application 404 sends the signed transaction back using a dedicated channel for sending signed transactions. The asset management application 402 can validate the transaction (426), for example, by confirming the signature is authentic using the public key of the associated wallet, and then send the transaction to the distributed ledger 410 to be persisted (428). In some implementations, the signed transaction is broadcasted to a number of distributed ledger nodes. In some implementations, the asset management application 402 may act or operate as a distributed ledger node itself, and submit the transaction for consensus by other distributed ledger nodes.

Once the transaction has been sent to the blockchain or distributed ledger, the asset management application 402 can send a message to the client device 408 confirming payment, or that the transaction has occurred 430. This allows the client device 408 or an associated entity to monitor the distributed ledger 410 for confirmation of the transaction. The asset management application 402 can then begin monitoring and verifying that the transaction is confirmed within the distributed ledger (432).

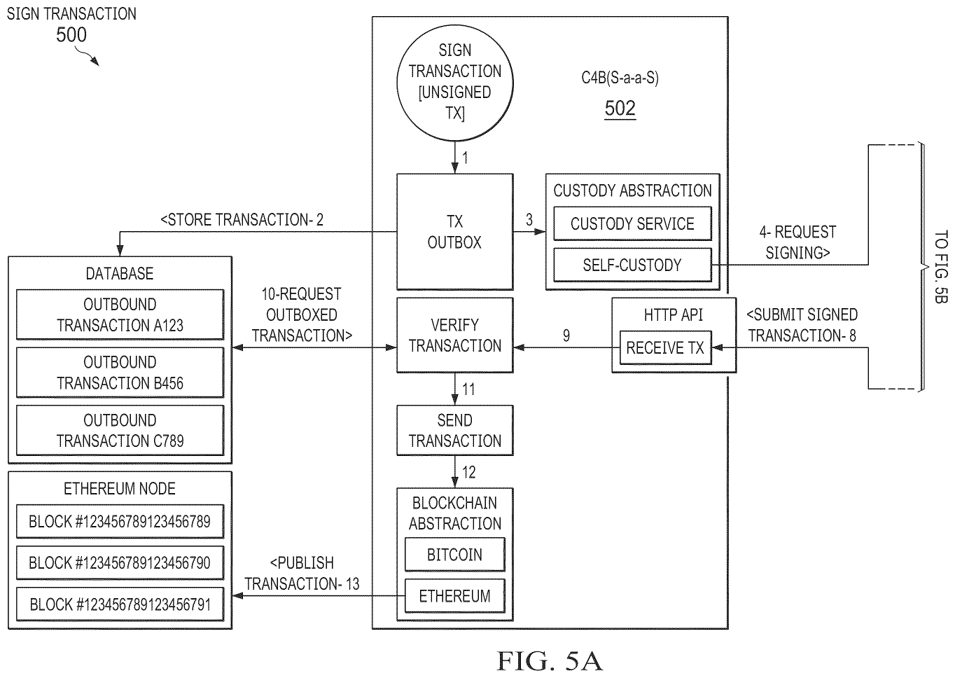

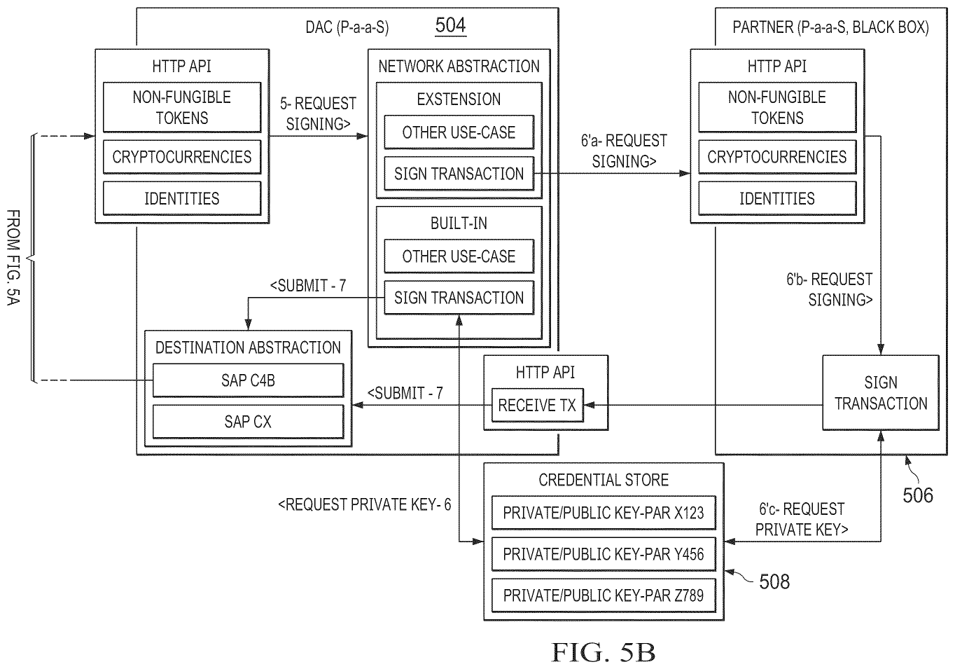

FIGS. 5A and 5B are a block diagram illustrating an example process 500 for enabling outbound cryptographic transactions. The crypto-for-business (C4B) module 502 can identify a transaction that needs to occur, and thus needs to be signed by the entity maintaining custody of the associated private key. The transaction can be submitted to a transaction outbox, then a custody abstraction module, which sends the transaction to a digital asset custody (DAC) system 504. This transaction can be sent to an HTTP API (or HTTPS API) and can include a request for sending a digital asset such as an NFT, one or more cryptocurrencies, and/or one or more digital identities. The DAC 504 can analyze the received transaction request, if it is maintaining the private key associated with the transaction locally, sign the transaction to be sent back to the C4B system 502. In some implementations, where the DAC 504 uses an external partner system 506 to maintain the private keys, the transaction can further be sent to the partner system 506 for signature. In some implementations, the external partner system 506 and the DAC 504 share a credential store 508, which can be a secure repository for public-private key pairs. Once the transaction is signed, it can be sent to a destination abstraction module within the DAC 504, which transmits the signed transaction back to the C4B system 502 via a dedicated channel. The dedicated channel can be an HTTP API (or HTTPS API) that exclusively receives signed transactions, and is different from the channel used to transmit the signature request to the DAC 504.

Upon receipt of the signed transaction, the C4B system 502 can verify the transaction, and approve it for sending to a distributed ledger. In some implementations, the approved transaction is sent to a blockchain abstraction module, which selects the appropriate blockchain based on the initial transaction request, and generates a transaction specific to that blockchain or distributed ledger (e.g., Ethereum, Bitcoin, Hyperledger, etc.). The transaction is then published to the appropriate blockchain, and notification can be sent to the owner of the wallet that the digital asset was sent to.

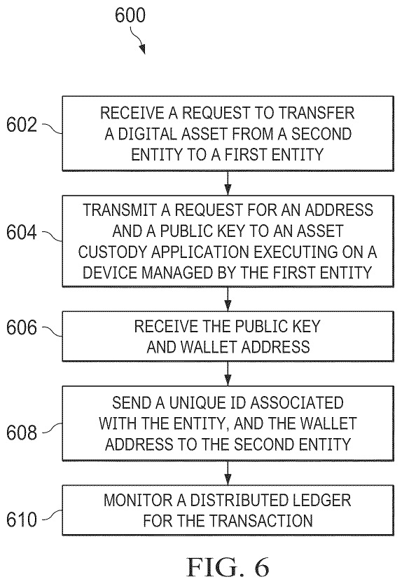

FIG. 6 is a flowchart of an example process 600 for receiving an inbound digital asset transaction by a self-custody management system. It will be understood that process 600 and related methods may be performed, for example, by any suitable system, environment, software, and hardware, or a combination of systems, environments, software, and hardware, as appropriate. For example, a system comprising a communications module, at least one memory storing instructions and other required data, and at least one hardware processor interoperably coupled to the at least one memory and the communications module can be used to execute process 600. In some implementations, the process 600 and related methods are executed by one or more components of the system 100 described above with respect to FIG. 1, such as the asset management system 102 and the customer managed custody system 116, and/or portions thereof.

At 602, a request is received to transfer a digital asset to a first entity. This request can be a request to make a payment (e.g., in cryptocurrency) based on a previously transmitted invoice. The request can specify a quantity of digital asset, or type of asset such as a particular currency (e.g., Bitcoin, Ethereum, NFT, or other digital asset), and an identity of the sending entity. The first entity can be a customer or client of a provider system that maintains custody of one or more digital wallets for cryptographic transactions. The request can be received at a management application that is executing as a cloud service and managed by the provider.

At 604, a request is transmitted to an asset custody application that executes on a device that is controlled or managed by the first entity. The request is for a wallet address and a public key to enable the digital asset to be transferred to the wallet. In some implementations, the wallet address and the public key are related or the same. For example, the wallet address can be based on, or generated using, the public key. In some implementations, only the wallet address is necessary for a third party to transfer a digital asset to that wallet. The wallet address can be a 42 character unique string, such as “0xacB39452d804c4ICAE2Ee19e18z8cBCf5D6204Ae.”

In response to the request, the asset custody application executing on the device that is controlled or managed by the first entity can generate a new digital wallet, where generating the new digital wallet can include generating a new key pair and a wallet address, where the new key pair includes a public key and a private key.

At 606, the public key and wallet address are received by the asset management application. It should be noted that the private key is not transferred to the asset management application, and is instead maintained at the asset custody application, which increases security and ensures compliance with the legal regulations of certain jurisdictions.

At 608, the asset management application sends the wallet address, as well as a unique ID or nickname associated with the digital wallet, to the sending entity. In some implementations, the asset management system publishes the wallet address and unique ID, as well as additional information, such as a public key associated with the wallet or an identification of the first entity, among other information. This published information can be used by the sending entity, or other services associated with the sending entity, to send a digital asset to the published wallet address.

At 610, the asset management application can monitor a distributed ledger associated with the wallet to confirm that the digital asset has been transferred to the wallet and the transaction has been incorporated into the distributed ledger. In some implementations, upon confirmation that the transaction is successfully incorporated into the distributed ledger, the asset management application sends a notification or confirmation message to the first entity and/or the asset custody application.

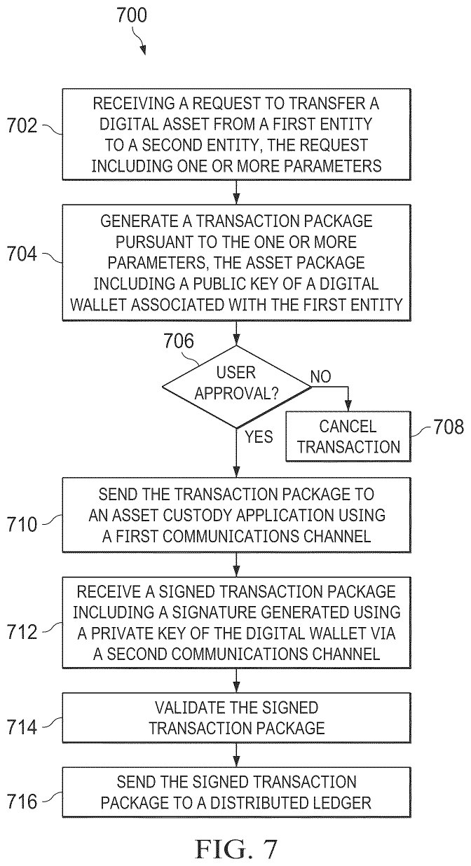

FIG. 7 is a flowchart of an example process 700, performed by a self-custody asset management system, for sending an outbound digital asset transaction to a distributed ledger. It will be understood that process 700 and related methods may be performed, for example, by any suitable system, environment, software, and hardware, or a combination of systems, environments, software, and hardware, as appropriate. For example, a system comprising a communications module, at least one memory storing instructions and other required data, and at least one hardware processor interoperably coupled to the at least one memory and the communications module can be used to execute process 700. In some implementations, the process 700 and related methods are executed by one or more components of the system 100 described above with respect to FIG. 1, such as the asset management system 102 and the customer managed custody system 116, and/or portions thereof.

At 702, a request to transfer a digital asset from a first entity to a second entity is received, where the request includes one or more parameters. The one or more parameters can be parameters that further define what the requested transaction is, and can include an amount or value, digital asset type, distributed ledger on which the transaction is to occur, date or time of the transaction, a wallet the digital asset is to be transferred to, as well as one or more parties associated with the transaction. Other suitable parameters may also be used.

At 704, an asset management system generates a transaction package pursuant to the one or more parameters. The transaction package includes a public key of a digital wallet associated with the first entity. This digital wallet is the wallet or application that is to supply the digital asset to the second entity (or a wallet associated with the second entity).

At 706, it is determined whether a user or customer associated with the first entity approves of the transaction. In some implementations, the transaction package is first sent to the customer or a device associated with the customer (e.g., client device 136 of FIG. 1) for approval. In some implementations, the transaction package is sent to an asset custody application for approval, where the asset custody application in turn solicits approval from the first entity, using either an automated process or requiring human approval. If the transaction package is rejected or not approved, or in some implementations, a timeout occurs after an approval is requested, then the transaction can be cancelled at 708. Upon approval, process 700 continues to 710.

At 710, the transaction package is sent to an asset custody application via a first communication channel. The first communication channel can be an HTTPS channel or other protocol hosted by the asset custody application. The transaction package can include one or more of the parameters, which can generally be at least the minimal parameters needed for a distributed ledger node to execute the transaction on the distributed ledger, except for a signature generated using a private key associated with the sending digital wallet. The transaction package can be signed by the asset custody application, which then generates a signed transaction package that is ready to be sent or broadcast to the distributed ledger network.

At 712, the signed transaction package is received at the asset management application from the asset custody application. The signed transaction package can be received via a second communication channel. The second communication channel can be a dedicated channel for receiving signed transaction packages that is separate and distinct from the first communication channel. In some cases, the second communication channel receives signed transaction packages exclusively from the asset custody application or a plurality of asset custody applications. In some implementations, the second communication channel is an HTTPS channel hosted as an API by the asset management application. By transmitting the signed package back to the asset management application using a separate, dedicated communication channel, security is enhanced. For example, if a fraudulent or malicious transaction was sent to the asset custody application from a third party, and the asset custody application signs the transaction, the signed transaction will not be sent back to that third party, but to the asset management application.

At 714, the asset management application verifies the signed transaction package received from the asset custody application. This verification can include, but is not limited to, a confirmation that the signed package matches a previously generated package where a signature was requested, a verification of the authenticity of the signature, and/or an additional confirmation that the user or customer consents to the transaction.

At 716, following successful verification of the signed transaction package, the signed transaction package is sent to the distributed ledger (or blockchain network) for processing. In some implementations, the signed transaction package is sent to a single node of the distributed ledger. In some implementations, the signed transaction package is broadcast to multiple nodes maintaining the distributed ledger. In some implementations, where the asset management application acts as a distributed ledger node itself, the signed transaction can be directly submitted for further consensus and commitment to the distributed ledger.

This detailed description is merely intended to teach a person of skill in the art further details for practicing certain aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

Unless specifically stated otherwise, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A computer-implemented method comprising:
receiving, at an asset management application executing as a cloud service managed by a provider, a request from a second entity to transfer a digital asset to a first entity;
sending a request for an address and public key to an asset custody application executing on a device that is managed by the first entity;
receiving, from the asset custody application, a public key and a wallet address; and
sending the wallet address to the second entity.

2. The method of claim 1, wherein the asset custody application maintains a private key associated with the wallet address on the device controlled by the first entity.

3. The method of claim 1, wherein the wallet address is used by a second entity to transfer a digital asset from the second entity to the first entity.

4. The method of claim 3, comprising monitoring a distributed ledger to confirm a transaction of a digital asset into a wallet associated with the wallet address has occurred.

5. The method of claim 1, wherein the provider is different from the first entity.

6. The method of claim 1, wherein the request to transfer the digital asset to the first entity comprises a digital asset type and identifies a distributed ledger on which a transaction transferring the digital asset to the first entity is to occur.

7. A non-transitory, computer-readable medium storing one or more instructions executable by a computer system to perform operations comprising:
receiving, at an asset management application executing as a cloud service managed by a provider, a request from a second entity to transfer a digital asset to a first entity;
sending a request for an address and public key to an asset custody application executing on a device that is managed by the first entity;
receiving, from the asset custody application, a public key and a wallet address; and
sending the wallet address to the second entity.

8. The non-transitory, computer-readable medium of claim 7, wherein the asset custody application maintains a private key associated with the wallet address on the device controlled by the first entity.

9. The non-transitory, computer-readable medium of claim 7, wherein the wallet address is used by a second entity to transfer a digital asset from the second entity to the first entity.

10. The non-transitory, computer-readable medium of claim 9, the operations comprising monitoring a distributed ledger to confirm a transaction of a digital asset into a wallet associated with the wallet address has occurred.

11. The non-transitory, computer-readable medium of claim 7, wherein the provider is different from the first entity.

12. The non-transitory, computer-readable medium of claim 7, wherein the request to transfer the digital asset to the first entity comprises a digital asset type and identifies a distributed ledger on which a transaction transferring the digital asset to the first entity is to occur.

13. A system comprising one or more computers and one or more non-transitory, computer readable medium on which are stored instructions that are operable, when executed by the one or more computers, to cause the one or more computers to perform operations, the operations comprising:
receiving, at an asset management application executing as a cloud service managed by a provider, a request from a second entity to transfer a digital asset to a first entity;
sending a request for an address and public key to an asset custody application executing on a device that is managed by the first entity;
receiving, from the asset custody application, a public key and a wallet address; and
sending the wallet address to the second entity.

14. The system of claim 13, wherein the asset custody application maintains a private key associated with the wallet address on the device controlled by the first entity.

15. The system of claim 13, wherein the wallet address is used by a second entity to transfer a digital asset from the second entity to the first entity.

16. The system of claim 15, the operations comprising monitoring a distributed ledger to confirm a transaction of a digital asset into a wallet associated with the wallet address has occurred.

17. The system of claim 13, wherein the provider is different from the first entity.

18. The system of claim 13, wherein the request to transfer the digital asset to the first entity comprises a digital asset type and identifies a distributed ledger on which a transaction transferring the digital asset to the first entity is to occur.
